(19) United States
(12) Patent Application Publication
(10) Pub. No.: US 2004/0111604 A1
(43) Pub. Date: Jun. 10, 2004

(54) Method and system for protection against unauthorized distribution of copyrighted computer files over peer-to-peer networks

(76) Inventor: Claude Fournier, (US)

Correspondence Address: Gaetan Prince, 25th Floor, 1100 West, Rene-Levesque blvd, Montreal, QC, H3B 5C9, CA

(21) Appl. No.: 10/726,480

(22) Filed: Dec. 4, 2003

(30) Foreign Application Priority Data
Dec. 5, 2002 (CA) 2,413,808

(51) Int. Cl. H04L 9/00

(52) U.S. Cl. 713/150

(57) ABSTRACT

A method and system for protection against unauthorized distribution of copyrighted computer files by end-users over a peer-to-peer (P2P) network make use of the viral aspect of P2P network by providing a computer server including corrupted version of the copyrighted computer files, by connecting the computer server to the P2P network, and by allowing access to such corrupted version. The versions of the copyrighted computer files are so corrupted as to allow their identification by peer end-users as being the corresponding copyrighted computer files.

### FIELD OF THE INVENTION

The present invention relates to peer-to-peer computer files distribution networks. More specifically, the present invention is concerned with a method and system for protection against unauthorized distribution of copyrighted computer files over peer-to-peer networks.

### BACKGROUND OF THE INVENTION

The popularity of personal computing among the general population continues to increase. Along with office automation applications and games, the Internet is largely responsible for the still-increasing popularity of personal computing. It is an understatement that the Internet has democratized access to information

In a sense, Internet has always been about sharing: friends and relatives sharing words and moments using e-mails and instant messaging, information holders sharing their knowledge with others via Web sites, companies sharing product information with potential clients and partners, etc. At first, the media was in the form of Bulletin Board System (BBS) and then it was in the form of Internet and Intranet networks. Today, even a computer game can be shared over the Internet. It is therefore not surprising that among the most commonly used Internet applications are the so-called file-sharing applications. These applications allow a plurality of users to easily share computer files.

The increasing popularity of personal computing is also partially due to the democratization of the computer means for copying digital media files, including music and video files. This has caused headaches to owners of copyrighted media content that are seeing their profits from the sell of copyrighted material decreasing or at least peeking, since more and more people are equipped to copy copyrighted material owned by friends and relatives or obtained over the Internet.

Of course encryption techniques have been used since the beginning of the personal computer history to limit the copying of computer files. However, it seems that computer pirates, i.e. people getting unauthorized access to encrypted files, most of the time seem to succeed in overruling the encryption techniques.

Of course, there is always the opportunity for the owner of copyrighted material to use legal means to prevent people from infringing their rights. However, the popularity of peer-to-peer networks, which allow many users to share computer files without requiring a central server, has made the determination of possible infringers more difficult. In any case, it is often unpractical to sue end-users.

There is therefore a need for a system and method for protection against unauthorized distribution of copyrighted computer flies over peer-to-peer networks.

### SUMMARY OF THE INVENTION

More specifically, in accordance with a first aspect of the present invention, there is provided a method for protecting against unauthorized distribution of a copyrighted digital file by end-users over a peer-to-peer (P2P) network, the method comprising:

providing at least one corrupted copy of the copyrighted digital file on a first computer server; the at least one corrupted copy sharing sufficient similarities with the copyrighted digital file so as to be identifiable by at least one of the end-users as the copyrighted digital file;

connecting the first computer server to the P2P network; and

allowing access to the at least one corrupted copy over the P2P network to the at least one of the end-users;

whereby, copying of the at least one corrupted copy by the at least one of the end-users yields a version of the at least one corrupted copy which becomes available through the peer-to-peer network and identifiable as the copyrighted digital file, thereby a) decreasing the probability that one of the end-users accesses the copyrighted digital file, b) diminishing the reliability of the peer-to-peer network, and c) contributing to dissuading unauthorized distribution of the copyrighted digital file over the peer-to-peer network.

According to a second aspect of the present invention, there is provided a system for protecting against unauthorized distribution of a copyrighted digital file by end-users over a peer-to-peer (P2P) network using respective end-user device configured to share digital files over the P2P network, the system comprising: a first computer server connected to the peer-to-peer network; the first computer server including at least one corrupted copy of the copyrighted digital file; the at least one corrupted copy sharing sufficient similarities with the copyrighted digital file so as to be identifiable by at least one of the end-users as the copyrighted digital file.

The system and method according to the present invention is advantageous since it allows an easy and relatively inexpensive way to dissuade end-users in a peer-to-peer network from trying to get unauthorized access to copyrighted files.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a block diagram illustrating a system for protection against unauthorized distribution of copyrighted computer files over peer-to-peer networks according to a first embodiment of the present invention;

FIG. 2 is a flow chart illustrating a method for protection against unauthorized distribution of copyrighted computer files over peer-to-peer networks according to an embodiment of the present invention; and

FIG. 3 is a block diagram illustrating a system for protection against unauthorized distribution of copyrighted computer files over peer-to-peer networks according to a second embodiment of the present invention.

### DETAILED DESCRIPTION OF THE INVENTION

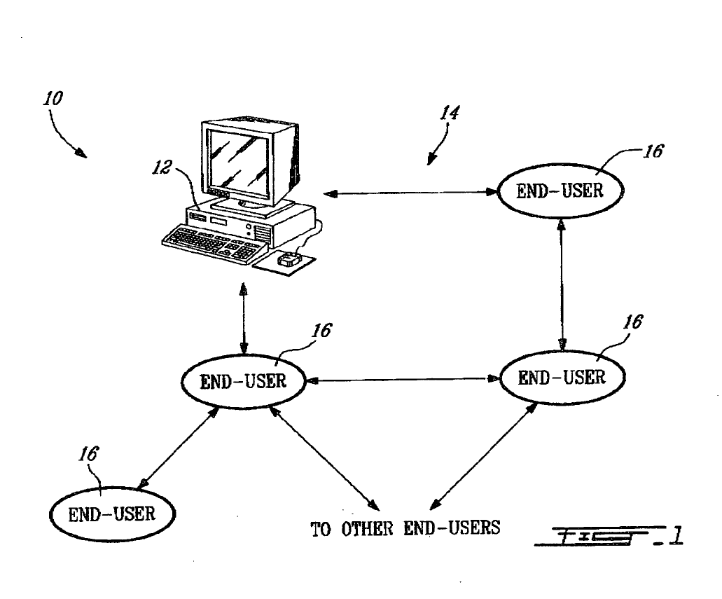

Turning to FIG. 1 of the appended drawings, a system 10 for protection against unauthorized distribution of copyrighted computer files by end-users over a peer-to-peer (P2P) network according to a first embodiment of the present invention is illustrated.

The system 10 comprises a computer server 12 connected to, and therefore part of, a peer-to-peer network 14. The peer-to-peer network 14 includes end-users 16 and may also include a host (not shown).

The term “end-user” (or peer) is to be construed herein as any computer or devices configured to be connected to a P2P network and for download and/or upload of computer files from and/or to other end-users.

Since peer-to-peer networks are believed to be well known in the art, they will not be described herein in more detail

Of course, in addition to the conventional connection means that allow the computer server 12 to access the P2P network 14, the computer server 12 is configured with appropriate peer-to-peer network account information so as to allow access to the P2P network 14. Such account information allows connectivity to the computer server 12 and access to selected files stored therein to other peers 16.

The selected files on the computer server 12 include corrupted copies (not shown) of copyrighted computer files for which dissuasion of unauthorized distribution is expected.

Indeed, methods and systems according to the present invention aim at diminishing the reliability of a P2P network 14 to end-users 16 by adding “pollution” to the network 14. As will be explained hereinbelow in more detail, the corrupted version of the computer files can be seen as pollution in the P2P network since they are unwanted by the end-users 16, useless to them and diminish the probability that end-user 16 find a specific file following a query over the P2P network. Such corrupted computer files contribute bringing uncertainty to end-users 16 as to the authentication of computer files downloaded from the end-users 16 part of the P2P network 14.

The corruption may take many forms, including: truncated files, file content not corresponding to the files attributes, lower quality files in case of multimedia files compare to the original files, partially incomplete files, and/or a file corresponding only partially to what its attributes may suggest. The corrupted version shares sufficient similarities with the copyrighted computer file so as to be identifiable by end-users as the copyrighted computer file.

It is to be noted that the term attribute should be construed as any information associated to a computer file that describes its content, including the name of the file, and that is used by end-users to identify a file. Since the concept of attribute is believed to be well known in the art, it will not be described herein in more detail.

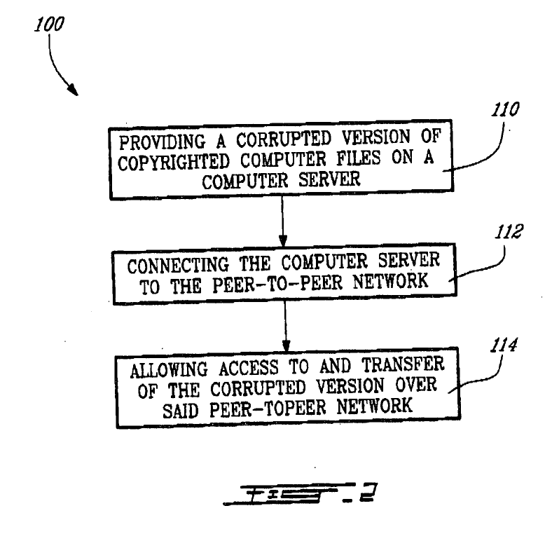

A method 100 for protection against unauthorized distribution of copyrighted computer files by end-users over a peer-to-peer (P2P) network according to an embodiment of the present invention is illustrated in FIG. 2 and is summarized as follows:

110—providing a corrupted version of copyrighted computer files on a computer server;

112—connecting the computer server to the peer-to-peer network; and

114—allowing access to and transfer of the corrupted version over the peer-to-peer network.

To avoid any infringement of copyrighted material, the owner of copyrighted material, an authorized user or a licensee, uses the method and system according to the present invention.

In a more specific example, the owner of songs may put corrupted version of those songs in a popular computer format such as MP3 or WAV. A file corresponding to a particular song may have a name corresponding to another song title, even from another artist. Alternatively or additionally, glitches or other unpleasant sounds may be added to the song before or after digitalisation and/or compression. Also, a song may be more compressed than what its attributes may suggest, therefore yielding a song with lesser audio quality.

Of course the nature of the corruption may vary. Alternatively many corruption schemes may be used for a single file. For example, a computer file having a name corresponding to a certain song title may correspond to another song; this other song may include glitches and may be abruptly interrupted.

The system and method according to the present invention takes advantages of the viral properties of P2P file sharing. Indeed, a single server connected to a P2P network may be accessed by a single user or a plurality of different user, each getting access to corrupted files and creating copy of those corrupted files on their computer system. These corrupted copies will, in turn, be accessed and copied by other peers according to the well-known P2P files distribution scheme.

Each further copy of the corrupted file decreases the probability that one of the end-users accesses the copyrighted computer file, diminishes the reliability of the peer-to-peer network, and contributes to dissuading unauthorized distribution of the copyrighted computer file over the peer-to-peer network.

Of course, the owner of copyrighted material may register itself on more than one P2P network and/or may advantageously allow other authorized peers to distribute corrupted files, increasing the distribution speed of the corrupted files. The targeted P2P network then becomes polluted with corrupted files. This should results in frustration to the end-user, that may then prefer to seek other files or to obtain copyrighted files through other file distribution technique that are either legal or at least more easy to identify for the copyright owner.

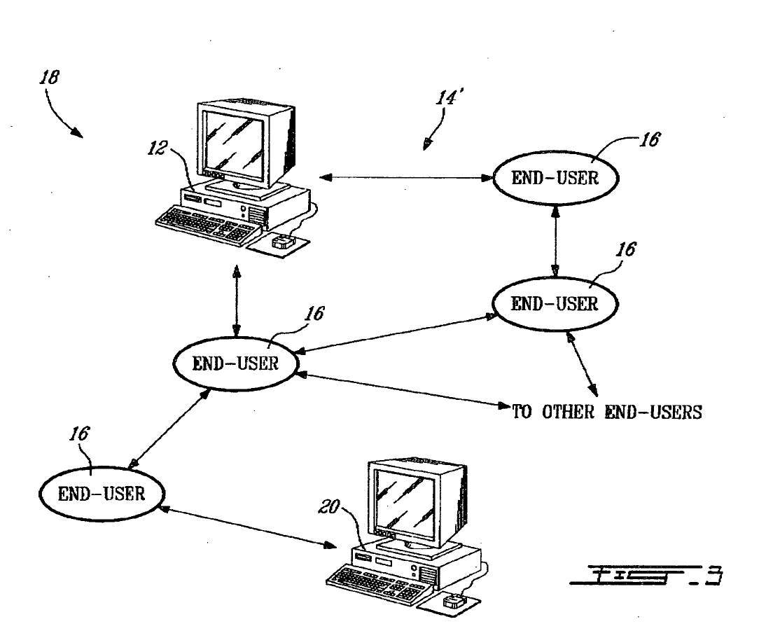

Turning now to FIG. 3, a system 18 for protection against unauthorized distribution of copyrighted computer files by end-users over a peer-to-peer (P2P) network, according to a second embodiment of the present invention is illustrated.

Since the system 18 is very similar to the system 10, only the major differences between the two systems will be described herein in further detail.

The system 18 comprises a second computer server 20 that is also configured so as to be part of the peer-to-peer network 14′. The server 20 is so located as to be remotely distanced geographically from the first computer server 12 so as to increase the distance between the two network nodes constituted by the two servers 12 and 20.

The second server 20 is configured to query the P2P network for copyrighted files covered by the system 18 and to monitor the occurrences of such copyrighted files among corrupted versions of such copyrighted files. Such monitoring may allow assessing the effectiveness of the system 18. In case where the probability of accessing copyrighted computer files covered by the system 18 over corrupted version of such files exceeding a predetermined threshold, access to more corrupted copies of the copyrighted material may be allowed by the servers 12 and/or 20 or another computer server configured similarly to the server 12 (not shown).

According to another embodiment, the corrupted version of copyrighted files may include identification means allowing easy recognition of such corrupted files by the second server 20.

Of course, the number of computer servers 12 and 20 may vary without departing from the spirit and nature of the present invention.

It is to be noted that the computer server 10 and 12 may take many forms, including a personal computer.

Although, the method and system according to the present invention has been described by way of reference mainly to sound files, it can also be used with computer application files, text files, video files, pictures, etc. In each case, the nature of corruption may vary from, for example, associating a computer file with a non-corresponding file name to adding data errors in the files.

Although the present invention has been described hereinabove byway of illustrative embodiments thereof, it can be modified without departing from the spirit and nature of the subject invention, as defined in the appended claims.

1. A method for protecting against unauthorized distribution of a copyrighted digital file by end-users over a peer-to-peer (P2P) network, said method comprising:
providing at least one corrupted copy of the copyrighted digital file on a first computer server; said at least one corrupted copy sharing sufficient similarities with said copyrighted digital file so as to be identifiable by at least one of the end-users as the copyrighted digital file;
connecting said first computer server to the P2P network; and
allowing access to said at least one corrupted copy over the P2P network to said at least one of the end-users;
whereby, copying of said at least one corrupted copy by said at least one of the end-users yields a version of said at least one corrupted copy which becomes available through the peer-to-peer network and identifiable as the copyrighted digital file, thereby a) decreasing the probability that one of the end-users accesses the copyrighted digital file, b) diminishing the reliability of the peer-to-peer network, and c) contributing to dissuading unauthorized distribution of the copyrighted digital file over the peer-to-peer network.

2. A method as recited in claim 1, wherein said at least one corrupted copy of the copyrighted digital file is selected from the group consisting of a truncated copy of the copyrighted digital file, a file including information not included in the copyrighted digital file, a copy of the copyrighted digital file having a lesser quality than the copyrighted digital file, and a partially incomplete copy of said copyrighted digital file.

3. A method as recited in claim 1, wherein said at least one corrupted copy of the copyrighted digital file includes a truncated copy of the copyrighted digital file, or a corrupted content that does not correspond to the content of said copyrighted digital file.

4. A method as recited in claim 1, wherein the copyrighted digital file is selected from the group consisting of a computer application related file, a text file, a video file, a digital picture, a sound file, and a music file.

5. A method as recited in claim 1, wherein said at least one corrupted copy of the copyrighted digital file includes at least one file attribute not corresponding to any file attribute of the copyrighted digital file.

6. A method as recited in claim 1, wherein the copyrighted digital file is in the form of an audio file including music.

7. A method as recited in claim 6, wherein said at least one corrupted copy of the copyrighted digital file is in the form of an MPEG Audio Layer 3 (MP3) or a WAV file.

8. A method as recited in claim 6, wherein said at least one corrupted copy of the copyrighted digital file includes glitches or noises.

9. A method as recited in claim 8, wherein said glitches or noises is added to the copyrighted digital file after digitalisation thereof.

10. A method as recited in claim 1, further comprising connecting a second computer server to the peer-to-peer network; said second computer server querying the P2P network for a copy of the copyrighted file, and monitoring occurrences of copies of the copyrighted file among corrupted copies of the copyrighted file.

11. A method as recited in claim 10, wherein said at least one corrupted copy of the copyrighted digital file includes identification means allowing identification of said at least one corrupted copy of the copyrighted digital file by said second computer server.

12. A system for protecting against unauthorized distribution of a copyrighted digital file by end-users over a peer-to-peer (P2P) network using respective end-user device configured to share digital files over the P2P network, said system comprising: a first computer server connected to the peer-to-peer network; said first computer server including at least one corrupted copy of the copyrighted digital file; said at least one corrupted copy sharing sufficient similarities with the copyrighted digital file so as to be identifiable by at least one of the end-users as the copyrighted digital file.

13. A system as recited in claim 13, wherein said corrupted copy of the copyrighted digital file is selected from the group consisting of a truncated copy of the copyrighted digital file, a file including information not included in the copyrighted digital file, a copy of the copyrighted digital file having a lesser quality than the copyrighted digital file, and a partially incomplete copy of said copyrighted digital file.

14. A system as recited in claim 13, wherein said first computer server includes account information allowing access to the P2P network by said first computer server and access to said at least one corrupted version of the copyrighted digital file to at least one of said end-users.

15. A system as recited in claim 13, further comprising a second computer server connected to the peer-to-peer network; said second computer server being configured for querying the P2P network for the copyrighted digital file and for monitoring occurrences of the copyrighted digital file among corrupted copies of the copyrighted digital file.

16. A system as recited in claim 15, wherein said at least one, corrupted copy of the copyrighted digital file includes identification means allowing identification of said at least one corrupted copy of the copyrighted digital file by said second computer server.

17. A system as recited in claim 13, wherein the copyrighted digital file is selected from the group consisting of a computer application file, a text file, a video file, a digital picture, a sound file, and a music file.

18. A system as recited in claim 13, wherein the copyrighted digital file is in the form of an audio file including music.

19. A system as recited in claim 13, wherein said at least one corrupted copy of the copyrighted digital file is in the form of an MPEG Audio Layer 3 (MP3) or a WAV file.

20. A system as recited in claim 13, wherein said corrupted copy of the copyrighted digital file includes glitches or noises.

21. A system as recited in claim 20, wherein said glitches or noises are added to the copyrighted digital file after digitalisation thereof.
